(19) United States
(12) Patent Application Publication
(10) Pub. No.: US 2013/0127867 A1
(43) Pub. Date: May 23, 2013

(54) FREESTYLE DRAWING SUPPORTED BY STENCIL EDGE SHAPES

(71) Applicants: Remon Tijssen, Mill Valley, CA (US); Timothy W. Kukulski, Oakland, CA (US)

(72) Inventors: Remon Tijssen, Mill Valley, CA (US); Timothy W. Kukulski, Oakland, CA (US)

(73) Assignee: ADOBE SYSTEMS INCORPORATED, SAN JOSE, CA (US)

(21) Appl. No.: 12/901,799

(22) Filed: Oct. 11, 2010

(51) Int. Cl. G06T 11/20; G06F 3/041

(52) U.S. Cl. 345/441; 345/173

(57) ABSTRACT

A graphical user interface displays a shape that is moveable from a first position in the graphical user interface to a second position. An input device receives freeform drawing data. The graphical user interface displays an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges. A processor detects an edge touching subset of the freeform drawing data that is drawn by the user at a time in which the edge touching subset of the freeform drawing data is touching at least one of the plurality of edges of the shape.

### BACKGROUND

1. Field

This disclosure generally relates to freeform drawing. More particularly, the disclosure relates to freeform drawing with edge detection.

2. General Background

Systems have been developed to allow users to draw various types of drawings. These systems vary in complexity so that a user ranging from the leisure artist to the professional developer has the tools that will be helpful in his or her artistic ventures.

Some of these systems allow a user to perform freeform drawing. The freeform drawing tool may be useful to a leisure or professional user. However, current freeform drawing tools are limited in their abilities. The user is not provided with enough supportive functionality to encapsulate the benefits of freeform drawing.

### SUMMARY

In one aspect of the disclosure, a computer program product is provided. The computer program product includes a computer useable medium having a computer readable program. The computer readable program when executed on a computer causes the computer to display, at a graphical user interface, a shape that is moveable from a first position in the graphical user interface to a second position in the graphical user interface. Further, the computer readable program when executed the computer causes the computer to receive, from an input device, freeform drawing data. In addition, the computer readable program when executed the computer causes the computer to display, at the graphical user interface, an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges. The computer readable program when executed the computer causes the computer to detect an edge touching subset of the freeform drawing data that is drawn by the user at a time in which the edge touching subset of the freeform drawing data is touching at least one of the plurality of edges of the shape. Further, the computer readable program when executed the computer causes the computer to prevent the edge touching subset of the freeform drawing data from being displayed in the graphical user interface.

In another aspect of the disclosure, a process is provided. The process receiving, from an input device, freeform drawing data. Further, the process receives, from an input device, freeform drawing data. In addition, the process displays, at the graphical user interface, an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges. The process also detects, with a processor, an edge touching subset of the freeform drawing data that is drawn by the user at a time in which the edge touching subset of the freeform drawing data is touching at least one of the plurality of edges of the shape. Further, the process prevents, with the processor, the edge touching subset of the freeform drawing data from being displayed in the graphical user interface.

In yet another aspect of the disclosure, a system is provided. The system includes an input device that receives freeform drawing data from a user. Further, the system includes a graphical user interface that displays a shape that is moveable from a first position in the graphical user interface to a second position in the graphical user interface and an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges. In addition, the system includes a processor that detects an edge touching subset of the freeform drawing data that is drawn by the user at a time in which the edge touching subset of the freeform drawing data is touching at least one of the plurality of edges of the shape and prevents the edge touching subset of the freeform drawing data from being displayed in the graphical user interface.

### DRAWINGS

The above-mentioned features of the present disclosure will become more apparent with reference to the following description taken in conjunction with the accompanying drawings wherein like reference numerals denote like elements and in which:

FIG. 1 illustrates a computing environment that may be utilized for edge detection with freeform drawing.

FIG. 2A illustrates an example of a circular shape that may be utilized by the user to restrict freeform drawing to being inside of the circular shape.

FIG. 2B illustrates an example of an alternative configuration any freeform drawing performed by the user outside of the circular shape is displayed and any freeform drawing performed inside the circular shape is not displayed.

FIG. 3A illustrates the circular shape located in a first position in the GUI.

FIG. 3B illustrates the circular shape located at a second position in the GUI as the circular shape moved from the first position to the second position.

FIG. 4 illustrates an example of edge detection performed with a combination of shapes.

FIG. 5 illustrates a process that may be utilized to perform edge detection with freeform drawing.

FIG. 6 illustrates a system configuration that may be utilized for edge detection with freeform drawing.

### DETAILED DESCRIPTION

An edge detection method, system, and computer program product are provided to expand the abilities of computerized freeform stencil drawing for a user. In one embodiment, a shape is provided on a graphical user interface (“GUI”) to allow the user to restrict the freeform drawing based on the shape. The shape may be any type of polygon, symbol, etc. In one embodiment, the shape is predefined. For example, a computer system may have a predefined shape for user by the user. Alternatively, the computer system may have a plurality of shapes from which the user may choose. In another embodiment, the shape is defined by the user. The user may draw a shape, select a shape, etc. for use with freeform drawing. Further, the user may be given one or more user controls for the shape. For example, the user may change the size of the shape, the color of the shape, etc.

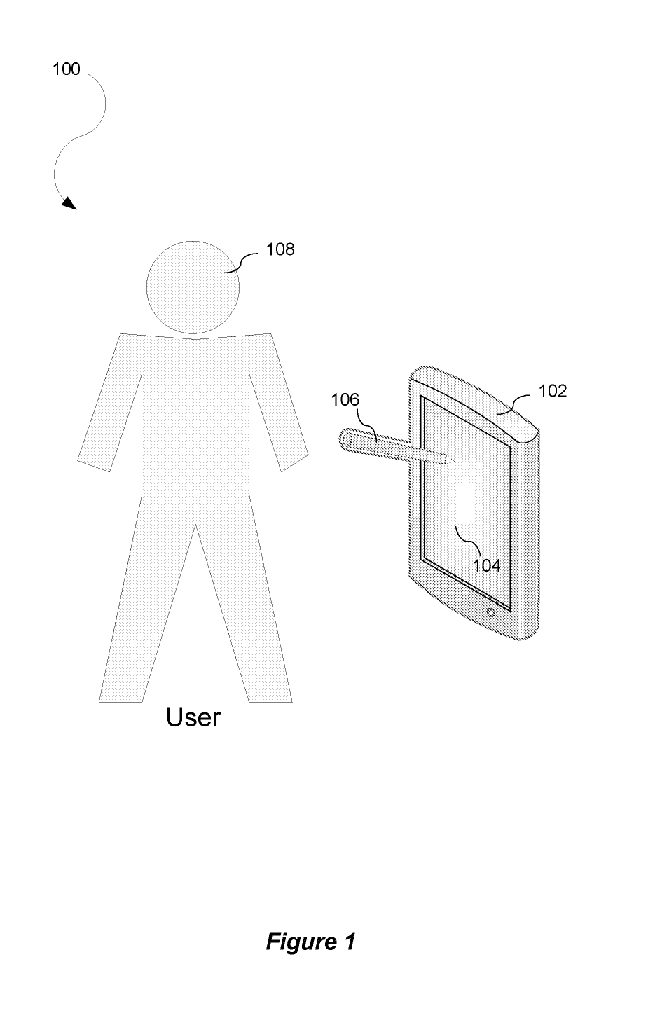

FIG. 1 illustrates a computing environment 100 that may be utilized for edge detection with freeform drawing. A computing device 102 has a GUI 104. An input device 106 receives freeform drawing data from a user 108. The computing device 102 may be any device with a processor such as a computer tablet, personal computer, laptop, notebook, cell phone, smart phone, personal digital assistant, personal medial player, set top box, etc. The computing device 102 is illustrated as a tablet only for illustrative purposes. Further, the input device 106 may be any device that sends data, directly or indirectly, for display on the GUI 104. For example, the input device 106 may be a computerized pen, computer mouse, touch screen, keyboard, stylus, etc. The input device 106 is illustrated as a computerized pen only for illustrative purposes. The input device 106 may be wireless or may have a hard wire connection to the computing device 102 and/or the GUI 104.

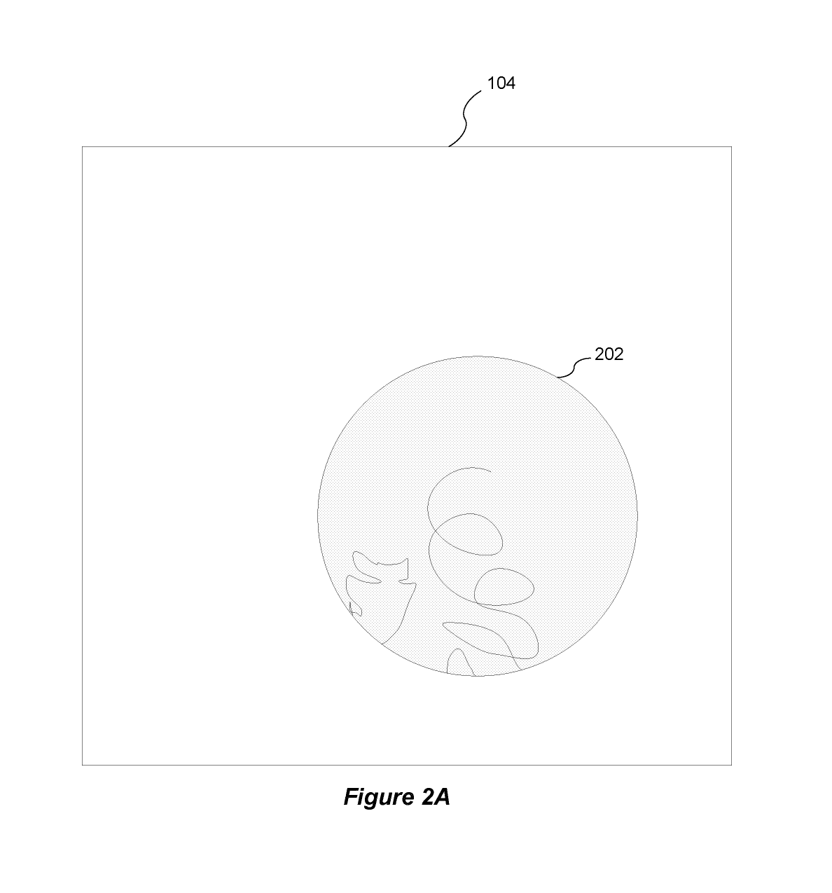

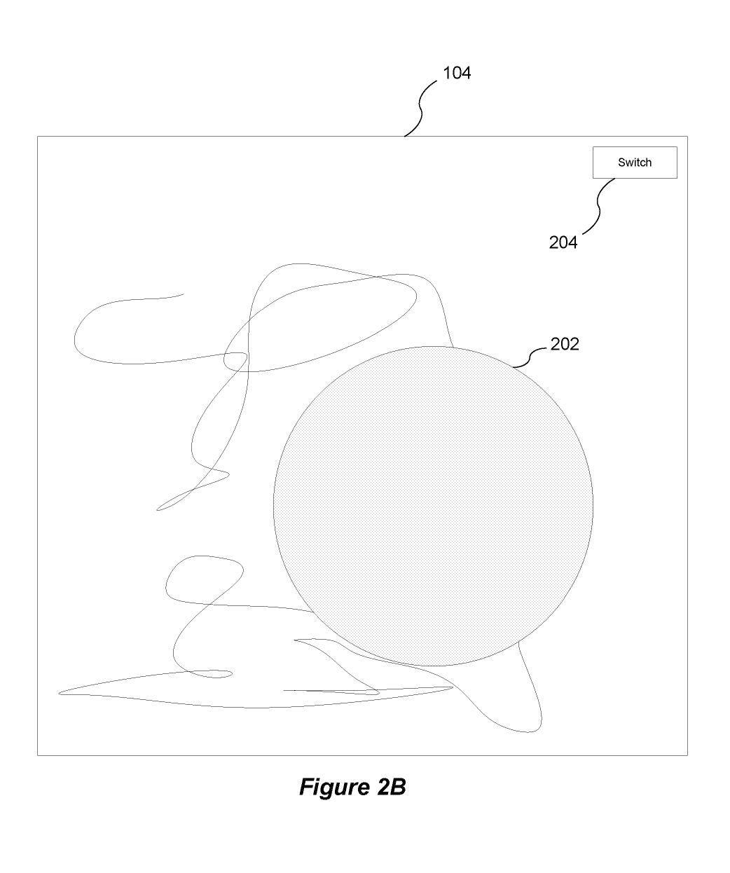

FIG. 2A illustrates an example of a circular shape 202 that may be utilized by the user to restrict freeform drawing to being inside of the circular shape 202. In one embodiment, the circular shape 202 is located in a fixed position within the GUI 104. The user may then draw inside and/or outside of the circular shape 202. In one configuration, any freeform drawing performed by the user inside of the circular shape 202 is displayed and any freeform drawing performed outside of the circular shape 202 is not displayed. Further, the edge detection may be automatically determined by a processor. In other words, the freeform drawing data received by the input device 106 may be a set of data that includes an edge touching subset, i.e., a portion, of the freeform drawing data that touches one or more edges of the circular shape 202 and an edgeless subset, i.e., a portion, of the freeform drawing data that does not touch any edge of the circular shape 202. An edgeless subset of freeform drawing data that is within a predetermined region with respect to each edge of the circular shape, e.g., inside of the circular shape 202, without touching an edge of the circular shape 202 is displayed whereas an edge touching subset of freeform drawing data that touches an edge is not displayed. Further, in one configuration, an edgeless subset that is drawn within an additional predetermined region that is distinct from the predetermined region, i.e., outside of the circular shape 202, is not displayed. The predetermined region may be inside, outside, or a different orientation with respect to the circular shape 202. Further, the additional predetermined region may be inside, outside, or a different orientation with respect to the circular shape 202 so long as the additional predetermined region is different than the predetermined region. In one embodiment, the predetermined region and the additional predetermined region do not share any pixels. In an alternative embodiment, the predetermined region and the additional predetermined region share one or more pixels and do not share one or more pixels.

In one embodiment, the shape is selected by the user from a predefined set of shapes. In another embodiment, the user freeform draws the shape and that resulting shape is utilized as the shape. In yet another embodiment, the shape may be scaled and/or rotated.

FIG. 2B illustrates an example of an alternative configuration any freeform drawing performed by the user outside of the circular shape 202 is displayed and any freeform drawing performed inside the circular shape 202 is not displayed. In other words, the subset of freeform drawing data that is outside of the circular shape 202 without touching an edge of the circular shape 202 is displayed whereas the subset of freeform drawing data that touches an edge is not displayed. Further, in one configuration, a subset that goes beyond the edge inside of the circular shape 202 is not displayed.

In one embodiment, the user may draw on the edge itself, but that freeform drawing data will be repositioned in a predefined position relative to the edge in the graphical user interface. For example, if the user is drawing outside of the circular shape 202 in FIG. 2B and draws a line on the edge of the circle, that line will be snapped to just outside of the edge. In one embodiment, just outside the edge may be the first empty pixels that are just outside the edge or the first available pixels within a small range of pixels so that the line is drawn visibly next to the edge. In another embodiment, the user may draw on the edge itself, but that freeform drawing data will be ignored.

In another embodiment, the user may draw in an additional predetermined region other than the predetermined region, but that freeform drawing data will be repositioned in a predefined position relative to an edge in the graphical user interface. For example, if the user initiates drawing outside of the circular shape 202 in FIG. 2B and draws a line from the inside of the edge to the center of the circular shape 202, that line will not be displayed within the circular shape 202, but rather will be displayed outside of the circular shape 202. The line may be snapped to just outside the edge or the first available pixels within a small range of pixels so that the line is drawn visibly next to the edge. In another embodiment, the user may draw within the circular shape 202, but that freeform drawing data will be ignored.

In yet another embodiment, the user may both draw on the edge itself and in the additional predetermined region so that the freeform drawing data is snapped to a position relative to the shape in which freeform drawing data may be displayed. If freeform drawing data is allowed on the outside of the shape, the freeform drawing data on the edge or within the shape is snapped to the outside of the shape. If freeform drawing data is allowed on the inside of the shape, the freeform drawing data on the edge or outside of the shape is snapped to the inside of the shape.

In any of the configurations provided herein, a feature may allow for a user to freeform draw on the stencil shape edge so that the freeform drawing is displayed on the edge. This feature may be predefined or user-defined. In another embodiment, this feature may be enabled or disabled by the user.

In one embodiment, the user is provided with a switch 204 to change the manner in which the freeform drawing is restricted. For example, the switch may initially be configured to restrict the user from drawing outside of the circular shape 202. The user may proceed with drawing to have some freeform drawing within the circular shape 202. Further, the user 108 may then choose to change the switch 204 so that freeform drawing is performed outside of the circular shape 202. As a result, the user may have a drawing with some freeform drawing inside of and some freeform drawing outside of the circular shape 202. In one embodiment, the system may autodetect inside the shape drawing or outside the shape drawing by determining the start position of the drawing. For example, if the user starts drawing at a position inside the shape, the user may indicate that he or she would like the system to perform inside the shape drawing whereas if the user starts drawing at a location outside of the shape, the user may indicate that he or she would like the system to perform outside of the shape drawing.

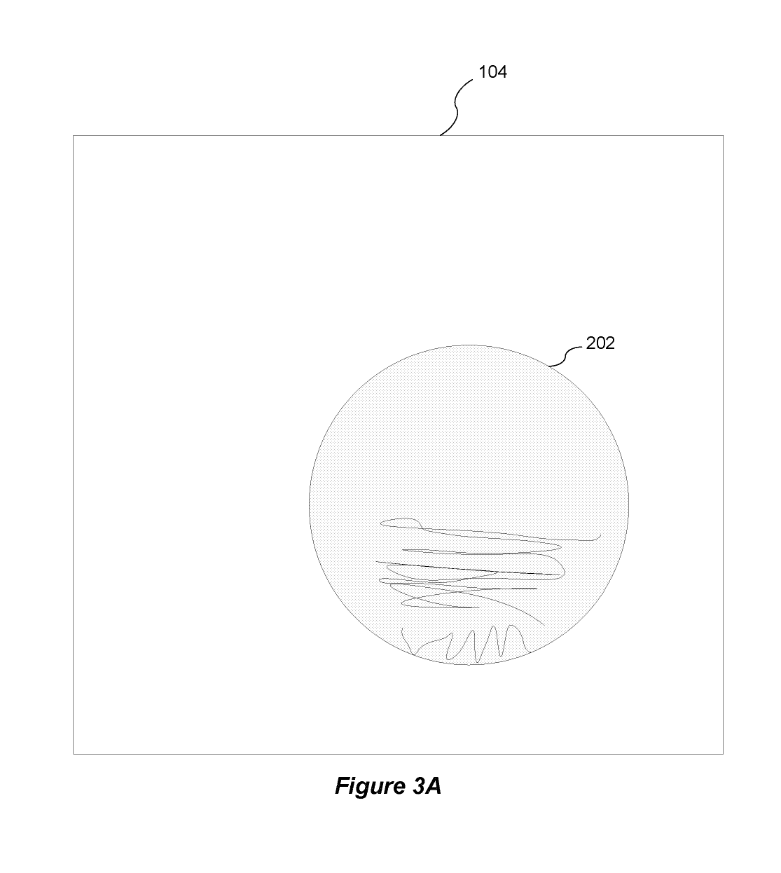

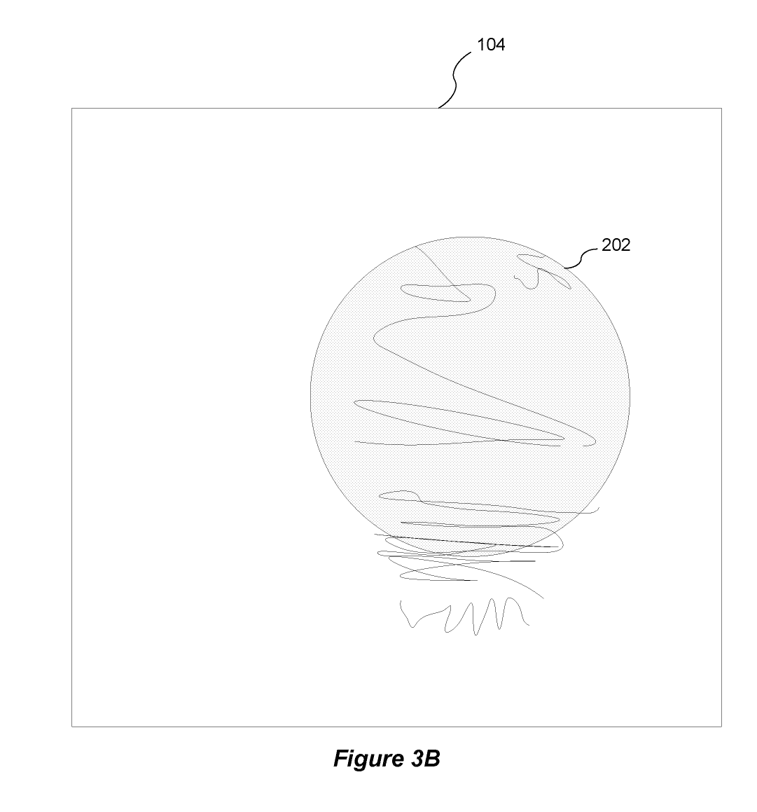

FIGS. 3A and 3B illustrate a configuration in which the shape is mobile. FIG. 3A illustrates the circular shape 202 located in a first position in the GUI 104. The user draws inside of the circular shape 202, and the freeform drawing data within the circular shape 202 is displayed without displaying freeform drawing data outside of the circular shape 202. FIG. 3B illustrates the circular shape 202 located at a second position in the GUI 104 as the circular shape 202 moved from the first position to the second position. The freeform drawing that was previously inside the circular shape 202 at the first position, but now outside the circular shape 202 at the second position, is still displayed. Further, any new freeform drawing data that occurs outside of the circular shape 202 at the time that the circular shape 202 is located at the second position is not displayed.

In one embodiment, the switch 204 may be utilized with the mobile shape. In other words, the user may choose to switch back and forth between restricting inside and outside freeform drawing.

In another embodiment, the mobile shape may move automatically. The speed of movement may be changed by the user. In one embodiment, the shape may be scaled, rotated, and/or repositioned simultaneously while drawing. In yet another embodiment, the user moves the mobile shape through a user input. In one embodiment, the movement is an animation. For example, the animation may be a path of the circular shape moving around the GUI 104. The animation may be custom defined by the user or predefined. In one embodiment, a user that would like to draw a pattern may do so with the assistance of the animated shape.

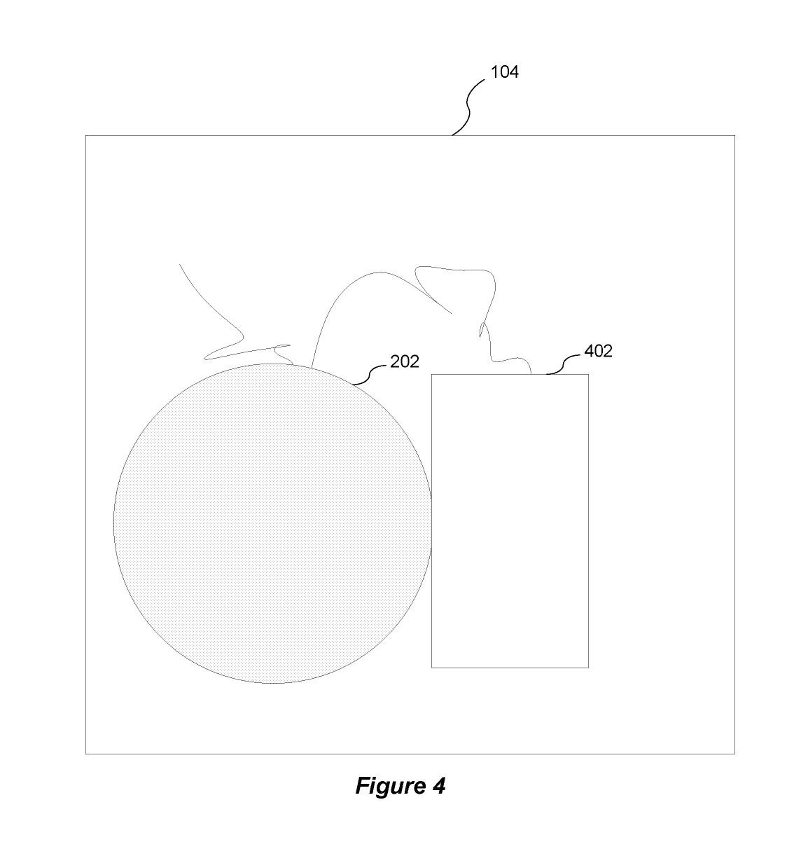

The edge detection described herein is not limited to any particular kind of shape. Further, the edge detection is not limited to any particular quantity of shapes. FIG. 4 illustrates an example of edge detection performed with a combination of shapes. As an example, the circular shape 202 illustrated in FIGS. 2A and 2B is utilized along with a rectangular shape 402. Any freeform drawing data drawn outside of the combination of these two shapes is displayed while any freeform drawing data drawn within these two shapes is not display in this example. As described herein, this configuration may be utilized with drawing on the inside, a switch, etc. In one embodiment, multiple shapes may be utilized to overlap so as to create a custom stencil shape.

With any of the configurations described herein, brush properties may change when an edge is detected. As an example, a drawing may be shown only when an edge is detected. Further, the visual appearance of the brush, e.g., brush size, brush color, brush opacity, brush type, or the like, may change when an edge is detected. For example, the edge may change from blue to red when an edge is touched.

Further, any of the configurations described herein may be utilized with a multi-touch based input device. An example of a touch based input device is a touch screen. The user is able to draw with his or her fingers. In one embodiment, different properties may be assigned to different fingers for a touch based input device. For example, if one finger is inside the edge, the system is configured to stop displaying freeform drawing data if the user's finger touches the edge and moves beyond the edge. The system may also be configured so that another finger of the user corresponds to displaying data outside of the edge so that if the user's finger touches the edge and moves inside the edge, that particular freeform drawing data for that finger is not displayed. Further, one hand may be utilized to touch the GUI 104 to move, size, and/or shape the drawing stencil in the GUI 104 while the other hand is utilized to touch the GUI 104 to perform freeform drawing.

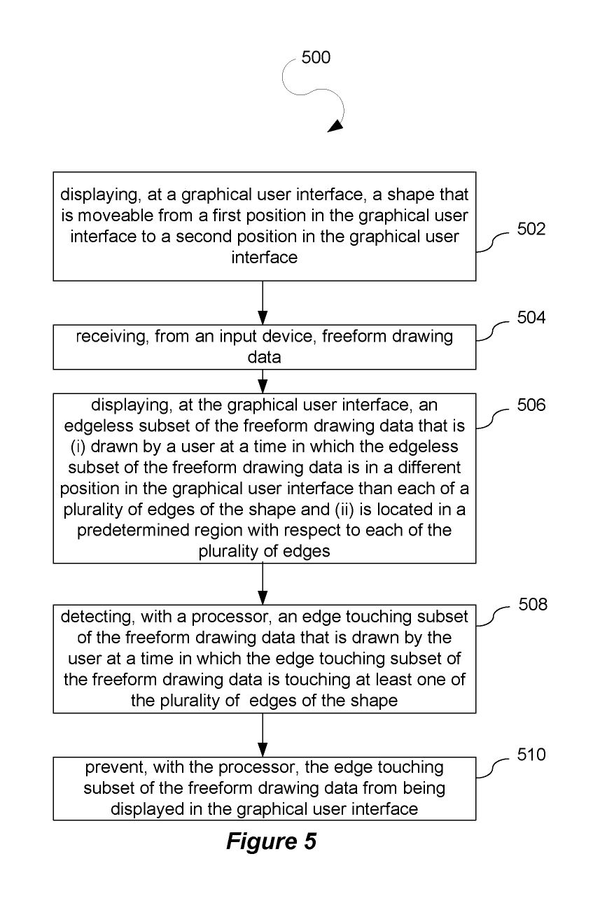

FIG. 5 illustrates a process 500 that may be utilized to perform edge detection with freeform drawing. At a process block 502, the process 500 displays, at a graphical user interface, a shape that is moveable from a first position in the graphical user interface to a second position in the graphical user interface. Further, at a process block 504, the process 500 receives, from an input device, freeform drawing data. In addition, at a process block 506, the process 500 displays, at the graphical user interface, an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges. The edgeless subset of the freeform drawing data is freeform drawing data that does not touch an edge of the shape. At a process block 508, the process 500 also detects, with a processor, an edge touching subset of the freeform drawing data that is drawn by the user at a time in which the edge touching subset of the freeform drawing data is touching at least one of the plurality of edges of the shape. Further, at a process block 510, the process 500 prevents, with the processor, the edge touching subset of the freeform drawing data from being displayed in the graphical user interface.

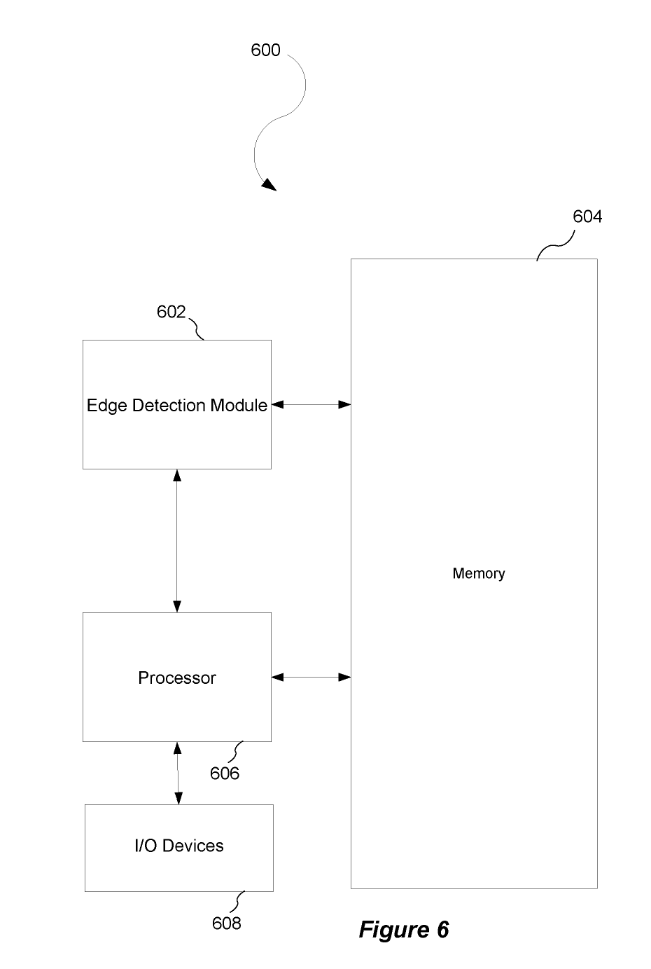

FIG. 6 illustrates a system configuration 600 that may be utilized for edge detection with freeform drawing. In one embodiment, an edge detection module 602 interacts with a memory 604. In one embodiment, the system configuration 600 is suitable for storing and/or executing program code and is implemented using a general purpose computer or any other hardware equivalents. The processor 606 is coupled, either directly or indirectly, to the memory 604 through a system bus. The memory 604 can include local memory employed during actual execution of the program code, bulk storage, and/or cache memories which provide temporary storage of at least some program code in order to reduce the number of times code must be retrieved from bulk storage during execution.

The Input/Output (“I/O”) devices 608 can be coupled directly to the system configuration 600 or through intervening input/output controllers. Further, the I/O devices 608 may include a keyboard, a keypad, a mouse, a microphone for capturing speech commands, a pointing device, and other input devices that will be recognized by one of ordinary skill in the art. Further, the I/O devices 608 may include output devices such as a printer, display screen, or the like. Further, the I/O devices 608 may include a receiver, transmitter, speaker, display, image capture sensor, biometric sensor, etc. In addition, the I/O devices 608 may include storage devices such as a tape drive, floppy drive, hard disk drive, compact disk (“CD”) drive, etc.

Network adapters may also be coupled to the system configuration 600 to enable the system configuration 600 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the processes and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes, systems, and computer program products. Therefore, it is to be understood that, within the scope of the appended claims, the present processes, systems, and computer program products may be practiced other than as specifically described herein.

We claim:

1. A computer program product comprising a computer useable medium having a computer readable program, wherein the computer readable program when executed on a computer causes the computer to:
display, at a graphical user interface, a shape that is moveable from a first position in the graphical user interface to a second position in the graphical user interface;
receive, from an input device, freeform drawing data;
display, at the graphical user interface, an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges;
detect an edge touching subset of the freeform drawing data that is drawn by the user at a time in which the edge touching subset of the freeform drawing data is touching at least one of the plurality of edges of the shape; and
prevent the edge touching subset of the freeform drawing data from being displayed in the graphical user interface.

2. The computer program product of claim 1, wherein the computer readable program when executed on the computer also causes the computer to display any freeform drawing data drawn on the edge in a predefined position relative to the edge in the graphical user interface.

3. The computer program product of claim 1, wherein the computer readable program when executed on the computer also causes the computer to ignore any freeform drawing data drawn on the edge.

4. The computer program product of claim 1, wherein the computer readable program when executed on the computer also causes the computer to prevent an additional edgeless subset of the freeform drawing data from being displayed in the graphical user interface and display the additional edgeless subset of the freeform drawing data in a predefined position relative to the edge in the graphical user interface, the additional edgeless subset of the freeform drawing data being (i) drawn by a user at a time in which the edgeless subset of the freeform drawing data is in a different position in the graphical user interface than each of a plurality of edges of the shape and (ii) located in an additional predetermined region with respect to each of the plurality of edges, the additional predetermined region being distinct from the predetermined region.

5. The computer program product of claim 1, wherein the computer readable program when executed on the computer also causes the computer to prevent an additional edgeless subset of the freeform drawing data from being displayed in the graphical user interface, the additional edgeless subset of the freeform drawing data being (i) drawn by a user at a time in which the edgeless subset of the freeform drawing data is in a different position in the graphical user interface than each of a plurality of edges of the shape and (ii) located in an additional predetermined region with respect to each of the plurality of edges, the additional predetermined region being distinct from the predetermined region.

6. The computer program product of claim 1, wherein the shape is selected from a predefined set of shapes.

7. The computer program product of claim 1, wherein the shape is drawn by the user through freeform drawing.

8. The computer program product of claim 1, wherein the shape is animated.

9. The computer program product of claim 1, wherein the predetermined region is a region inside each of the plurality of the edges of the shape at the time in which the edge touching subset of the freeform drawing data is touching the at least one of the plurality of edges of the shape.

10. The computer program product of claim 9, wherein the computer readable program when executed on the computer also causes the computer to prevent display of freeform drawing data outside of the region inside each of the plurality of the edges of the shape at the time in which the edge touching subset of the freeform drawing data is touching the at least one of the plurality of edges of the shape.

11. The computer program product of claim 1, wherein the predetermined region is a region outside each of the plurality of the edges of the shape at the time in which the edge touching subset of the freeform drawing data is touching the at least one of the plurality of edges of the shape.

12. The computer program product of claim 11, wherein the computer readable program when executed on the computer also causes the computer to prevent display of freeform drawing data inside of the region inside each of the plurality of the edges of the shape at the time in which the edge touching subset of the freeform drawing data is touching the at least one of the plurality of edges of the shape.

13. The computer program product of claim 1, wherein the computer readable program when executed on the computer also causes the computer to change a color of a drawing tool upon the detection of the edge touching subset of the freeform drawing data that is drawn by the user at the time in which the edge touching subset of the freeform drawing data is touching the edge of the shape.

14. The computer program product of claim 1, wherein the computer readable program when executed on the computer also causes the computer to change a size of a drawing tool upon the detection of the edge touching subset of the freeform drawing data that is drawn by the user at the time in which the edge touching subset of the freeform drawing data is touching the edge of the shape.

15. The computer program product of claim 1, wherein the computer readable program when executed on the computer also causes the computer to change an opacity of a drawing tool upon the detection of the edge touching subset of the freeform drawing data that is drawn by the user at the time in which the edge touching subset of the freeform drawing data is touching the edge of the shape.

16. A method comprising:
displaying, at a graphical user interface, a shape that is moveable from a first position in the graphical user interface to a second position in the graphical user interface;
receiving, from an input device, freeform drawing data;
displaying, at the graphical user interface, an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges;
detecting, with a processor, an edge touching subset of the freeform drawing data that is drawn by the user at a time in which the edge touching subset of the freeform drawing data is touching at least one of the plurality of edges of the shape; and
preventing, with the processor, the edge touching subset of the freeform drawing data from being displayed in the graphical user interface.

17. The method of claim 16, wherein the wherein the shape is selected from a predefined set of shapes.

18. The method of claim 16, wherein the shape is drawn by the user through freeform drawing.

19. The method of claim 16, wherein the shape is animated.

20. A system comprising:
an input device that receives freeform drawing data;
a graphical user interface that displays a shape that is moveable from a first position in the graphical user interface to a second position in the graphical user interface and an edgeless subset of the freeform drawing data that is (i) drawn by a user at a time in which the edgeless subset of the freeform drawing data is in a different position in the graphical user interface than each of a plurality of edges of the shape and (ii) is located in a predetermined region with respect to each of the plurality of edges; and
a processor that detects an edge touching subset of the freeform drawing data that is drawn by the user at a time in which the edge touching subset of the freeform drawing data is touching at least one of the plurality of edges of the shape and prevents the edge touching subset of the freeform drawing data from being displayed in the graphical user interface.
